(19) United States
(12) Patent Application Publication
(10) Pub. No.: US 2024/0059276 A1
(43) Pub. Date: Feb. 22, 2024

(54) METHOD AND DEVICE TO IMPROVE MILEAGE

(71) Applicant: Yellowbird Products Ltd., Calgary (CA)

(72) Inventors: Peter O. Paulson, Calgary (CA); James E. Paulson, Calgary (CA)

(21) Appl. No.: 18/451,600

(22) Filed: Aug. 17, 2023

Related U.S. Application Data
(60) Provisional application No. 63/399,126, filed on Aug. 18, 2022.

(51) Int. Cl. B60W 30/045; B60W 30/18; B60W 30/14; B60W 50/14

(52) U.S. Cl. CPC B60W 30/045; B60W 30/18145; B60W 30/143; B60W 50/14; B60W 2555/20; B60W 2552/00; B60W 2554/80; B60W 2050/146

(57) ABSTRACT

Methods and systems for controlling energy consumption, operational management and efficacy of a vehicle are disclosed. The method includes providing, by a processor, a guidance file for a trip of the vehicle; and using, by the processor, the guidance file using vehicle position, and one or more of energy consumption, speed, and operational parameters of the vehicle in the trip.

### CROSS-REFERENCE TO RELATED APPLICATION

The present application claims priority over the U.S. provisional application No. 63/399,126, entitled “METHOD AND DEVICE TO IMPROVE MILEAGE”, filed on Aug. 18, 2022, the contents of which are incorporated in the present application in its entirety.

### FIELD

The present application relates to vehicle drive management, in particular, to methods and devices for drive management and improving mileage of a vehicle.

### BACKGROUND

The reduction of fuel consumption in motorized vehicles has been a goal for many years. Most of the efforts have been directed to reducing weight, increasing engine efficiency, and reducing the drag of vehicles in order to reduce fuel consumption. There is a practice called “hypermiling” utilized by some motorists. The practice involves conserving fuel by using certain driving practices that tend to reduce fuel consumption.

One example is the practice of conserving kinetic energy to the extent practical while following the rules of the road but altering speeds somewhat to conserve as much kinetic energy as possible. The view of this practice is that if the brakes are used, kinetic energy is wasted or partly wasted using regenerative braking technology. For example, if a red stoplight can be seen at the bottom of a hill, allowing the velocity of the car to reduce so that the vehicle does not need to stop at the light, but instead it just slows in anticipation of the light turning green before the car reaches the stoplight.

### SUMMARY

By adding other data and methods as described above, and by enabling a processing system to control more of the systems in the vehicle, substantial fuel savings can be realized under certain conditions.

The present application measures and compares actual results on roadways, with other results on similar or identical traverses, constantly seeking to optimize the use of data from the variables to produce the optimal efficiency results. By deliberately altering the pattern of control, the optimizing system involved may explore the effect of altering parameters to seek even greater improvement in efficiency.

In an aspect, there is provided a method for controlling energy consumption of a vehicle which is disclosed. The method includes providing, by a processor, a guidance file for a trip of the vehicle; and using, by the processor, the guidance file to control one or more of the energy consumption, speed, and operational parameters of the vehicle in the trip.

### BRIEF DESCRIPTION OF THE DRAWINGS

Reference will now be made, by way of example, to the accompanying drawings which show example embodiments of the present application, and in which:

FIG. 1 is a diagram of a system, according to an embodiment of the present application; and

FIG. 2 is a flow chart illustrating a method, according to an embodiment of the present application.

Similar reference numerals may have been used in different figures to denote similar components.

### DESCRIPTION OF EXAMPLE EMBODIMENTS

The present invention utilizes a combination of features, methods, and devices to minimize the fuel consumed on a known route. The term “energy” or “fuel” in the present application refers to any energy source that may be used to drive a vehicle, including gasoline, diesel, hydrogen and other combustibles, and electrical energy utilized in hybrid and electric plug-in vehicles and hybrid plug-in vehicles.

Certain driving practices can greatly influence the efficiency of a vehicle. Modern vehicles have strong computerized systems that collect some of the information needed to automate the process of optimizing the operation of the vehicle for reduced fuel consumption.

Computer assisted control of a vehicle can utilize experience on or knowledge of the roadway being travelled including information from traffic monitoring equipment and networks, geographic database data, weather, and visual and other clues.

For example, if a suitable mileage improvement system is engaged, it may allow the user to accelerate at only a predetermined rate to save fuel but while maintaining a velocity sufficient to efficiently reach a velocity-constraining road or traffic feature ahead. Such a method may disengage the braking of the vehicle and allowing slightly faster velocity to be attained descending hills than ascending hills, turning off and restarting the engine at appropriate times estimated from the predicted need dictated by conditions that will be encountered.

In the present application, if one knows the characteristics of the roadway on which a vehicle travels, it is possible to reduce fuel consumption by anticipating features in the roadway that affect the movement of the vehicle and optimize the application of the throttle and brake and other operational features of the vehicle to reduce fuel consumption. While it is possible to simply make oneself familiar with a given roadway and drive in a manner that reduces fuel consumption, the assistance of automated methods may be more effective and be easier to execute. As well, the use of data collected by earlier traverses of the roadway will allow the implementation of actual experience into the algorithm estimating the most efficient actions, for example, via AI Model training based on driving experience. The use of experience on a particular roadway also may involve the characteristics of the vehicle being used, road surfaces, and even traffic patterns previously encountered. By including the mass of the vehicle in the estimations, the fuel consumption can be tailored to the immediate situation, such as when implemented in a truck which may or may not be carrying a heavy load.

Each vehicle and each roadway have characteristics of energy consumption that result from both design and maintenance of both the vehicle and the roadway, as well as on the ambient conditions in which the vehicle will operate.

For example, if a vehicle approaches a curve in the roadway that requires the vehicle to decelerate to safely pass the curve, there is no need for the vehicle to maintain full speed right up to the moment that the driver must apply the brake. By allowing the vehicle to slow somewhat as it approaches the curve, less energy is wasted. Another example is the ascent of hills and descent of hills. If the vehicle is allowed to slow slightly as it ascends a hill and allowed to increase speed slightly as it descends hills, less fuel is used. Similarly, blind approaches to yield or stop signs can be anticipated to allow the vehicle to slow somewhat as it approaches such features in the roadway.

The slowing and velocity increases can also involve shutting off the engine or drive system entirely when hills of sufficient negative grade are anticipated and encountered.

If a record is kept of the passage of a vehicle over a given stretch of roadway, the system in the present application is configured to refine the operation of the vehicle during subsequent passages to improve mileage, reduce wasted time, or even increase average speed while optimizing fuel consumption.

Even on straight level roadways, certain patterns of speed changes have been shown to reduce fuel consumption. General practices known to increase efficiency of vehicles such as “pulsing” the speed, can be part of the automated process that will result from the use of the data collected. The practice of “pulsing” wherein one deliberately accelerates then decelerates slightly can reduce fuel consumption on some vehicles. The application of this technique uses position information such as that described here to determine the actual optimum acceleration slope, deceleration slope during the glide, and the optimum provision of input power at the best times.

The combination and choice of the best practices to minimize fuel consumption may change depending on the vehicle, the prevailing weather conditions, traffic conditions, and the road chosen. It is the goal of the present application to provide features in the vehicle that assist the driver in making the best choices, and in implementing changes in the behaviour of the vehicle to achieve the desired optimal combination of speed, time, and fuel consumption of a vehicle.

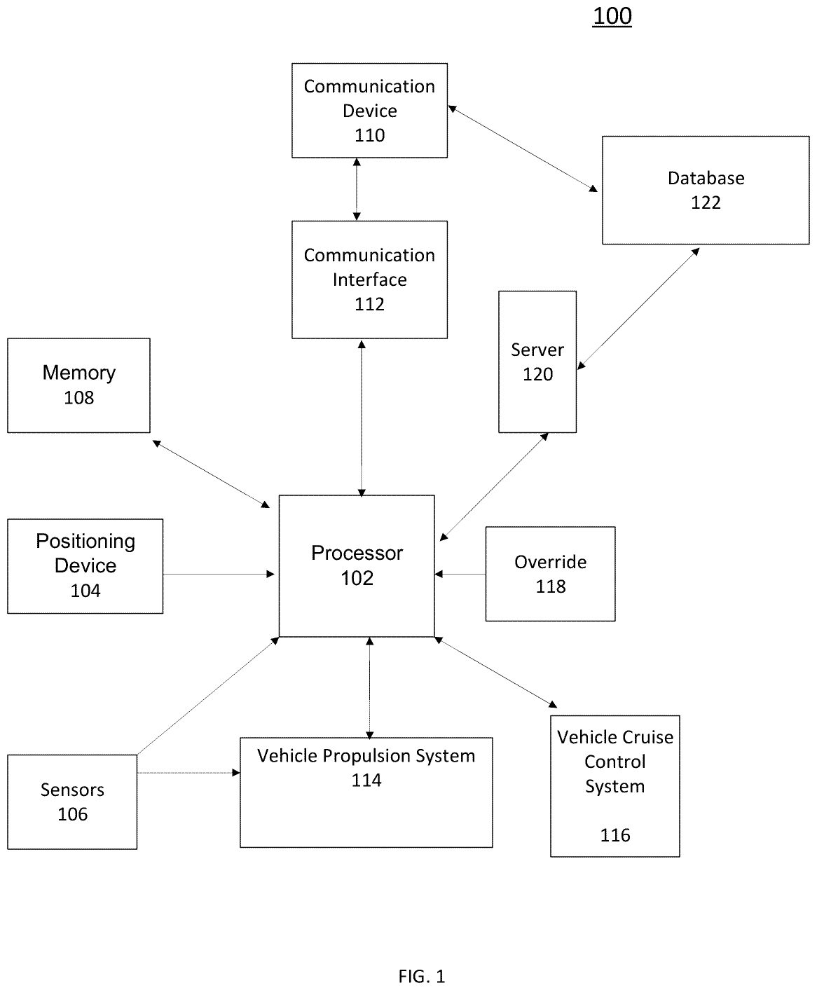

FIG. 1 is a diagram of a system 100 for optimizing mileage by controlling energy consumption of a vehicle, according to an embodiment of the present application. The system 100 may be installed in a vehicle for optimizing mileage of the vehicle. For example, the system 100 may be installed by a mechanic by supplying power with the battery of the vehicle to the system 100 and connecting the system 100 to the vehicle's cruise control interface for the system 100 to control the speed, acceleration, deceleration, at selected times on a roadway.

The system 100 comprises one or more processors 102. In some examples, the system 100 may also include one or more positioning devices 104, one or more sensors 106, and a memory 108.

The positioning device or devices 104 is configured to determine the position of the vehicle, such as a GPS receiver. The positioning device 104 may be integrated in the system 100. The positioning device 104 may be external to the system 100, such as the GPS provided by the vehicle, or the GPS provided by a user communication device 110, such as a smart phone, via a communication interface 112. The positioning device 104 provides real time location of the vehicle on a road, and information of the path of the road, including elevation changes. The positioning device 104 also enables the use of past experience on the roadway to be utilized in improving fuel consumption, for example, by storing the coordinates of the vehicle on the road and fuel consumption at each location of road in the memory 108. This may include imaging or other inputs to better assess the operational situation surrounding the vehicle.

The sensors 106 are configured to measure selected parameters or characteristics of the vehicle, such as the speed, acceleration, and deceleration of the vehicle. The sensors 106 may also measure environmental data of the vehicle, such as humidity, temperature, stoplight status, etc. The sensors 106 may be integrated in the system 100. The sensors 106 may be installed within the vehicle or operationally connected to the vehicle for measuring characteristics of the vehicle and the roadway.

The sensors 106 may also be external to the system 100, such as the sensors provided by the user communication device 110, such as a smart phone, via the communication interface 112, or sensors existing on the vehicle. The sensors 106 in this case can measure the speed, acceleration, deceleration of the vehicle when the user communication device 110 is traveling in the vehicle. The sensors 106 may also include one or more fuel flow sensors of the vehicle to measure the real time fuel consumption of the vehicle.

The processor 102 may use the measurement data from the sensors 106 in improving the efficiency of the vehicle. The measurement data can be used in real time to control the operation of vehicle to achieve optimal mileage or saved in the memory 108 for future use on roadways that are similar or in the case of repeating the operation on a given roadway, used in comparison to future traverses.

The memory 108 is configured to store the measurement data from the positioning device 104 and the sensors 106, and operational data of the vehicle, such as speed, acceleration, deceleration, and fuel consumption at specific time points or durations. The memory 106 may be mounted within the vehicle, or external to the vehicle, such as the cloud. The memory 108 may be accessed by a communication channel, such as a wireless communication channel from the vehicle.

The processor or controller 102 is configured to utilize the data from the positioning device 104, and from the operational inputs from the vehicle to make the best estimate of operating behaviour to optimize fuel consumption of the vehicle.

For example, there may exist on the roadway being travelled, an area where bridge icing is common if the outside temperature is below freezing, and where rain is present. The processor or controller 102 is configured to reduce the speed of the vehicle before the area, such as a bridge deck, in anticipation of the potential slippery problem without using the brakes of the vehicle. In another example, during more than one previous traverses, the driver applied the brakes at a position that is not otherwise noted by roadway markings. Based on the previous traverses, the processor or controller 102 is configured to utilize the data from the positioning device 104 for the location information of the brakes applied to estimate possible brakes and to optimize fuel consumption of the vehicle.

The operational inputs include fuel consumption, velocity, outside temperature, oxygen levels, engine conditions, transmission state, rolling friction, tire inflation pressure, load in the vehicle, cabin temperature, and other data that can be used to optimize fuel consumption.

In some examples, the processor 102 is configured to communicate with a vehicle propulsion system 114, which may include the engine, the clutch or transmission, brakes, air conditioner, alternator, fuel injectors, and other elements of the vehicle-related energy supply or speed control. By communicating with the vehicle propulsion system 114, the processor 102 has the information of the operating information including fuel consumption of the vehicle in a selected period and road or location.

With the fuel consumption of the vehicle, the speed, the acceleration, deceleration, and braking information of the vehicle, the processor 102 is configured to control the operation of the vehicle with the optimal mileage. For example, the processor 102 can control the vehicle by controlling the cruise control system 116 of the vehicle. The system 100 may maintain the vehicle operating on a selected road with the optimal mileage by controlling the vehicle speed, by maintaining the speed, accelerating or decelerating the speed, at a selected range and at a selected section or location of the road, in view of the condition of the road, the operation parameter of the vehicle, and the collected measurement data from the sensors 106 and the positioning device 104.

Optionally, the system 100 may include an override 118 where the driver can quickly or continuously exert complete or partial control of the vehicle acceleration. For example, if the system 100 is engaged, the operator may press the accelerator to midpoint, but the system 100 will modify that to only allow a slower acceleration. If the operator moves the accelerator past the mid-point, the system 100 no longer controls the acceleration rate.

In an example, the processor 102 is configured to access a remote server 120 including a cloud server, for example, via a wireless communication link. The server 120 is configured to store data from vehicles that have traversed the same roadway. The server 120 may utilize the stored data in selecting the optimum operation under the current conditions, using the current vehicle or current type of vehicle, or if none are available, other types of vehicles.

The processor 102 may also provide measurement data and/or vehicle operational data stored in the memory 108, or measurement generated from the positioning device 104 and sensors 106 to the server 120 for use by the system 100 installed in other vehicles. The server 120 may save the measurement data and/or vehicle operational data from the system 100 in a database 122. The database 122 may store maps, road characteristics, measurement data and/or vehicle operational data from system 100.

In an example, a driver with the system 100 traverses a certain section of roadway. The processor 102 is configured to operate within bounding conditions such as maximum and minimum speeds allowed, by posted speed limits, or by driver choices, or both. The sensors 106 may measure the slopes of the roadway and vary operational parameters available while recording the results. Sometimes, the actual optimal parameter values may differ from the original estimate because of the unexpected influence of one of the controlled or uncontrolled variables being used to make decisions. By deliberately varying some of the parameters, the performance of the system 100 can be continuously improved by identifying the optimal parameter configurations with respect to energy consumption. The processor 102 may recognize that at slopes of a range, such as 0 to minus 1% grade, the speed of the vehicle produces the greatest efficiency at a specific speed, such as around 52 km/h. The processor 102 may also determine that on slopes of −2% to −4%, the optimum efficiency is around 57 km/h. Further, the processor 102 may determine that at grades of 1% to 3%, a slow deceleration of 1 km/h each second, reduces the total amount of fuel or energy consumption required to ascend a hill of that grade. Using positioning device 104 such as GPS or other location determining data, the processor 102 determines that there is an upcoming series of elevation changes that can expose the vehicle to the different grades. For example, in anticipation of the first +2% grade, the processor 102 may accelerate the vehicle to achieve 59 km/h just as the vehicle commences the ascent. The processor 102 then may allow the vehicle to slow at a rate of 1 km/h each second until the summit has been achieved and a slow acceleration down the negative slope following can begin.

In subsequent trips over the same roadway, the processor 102 may alter the rate of speed increase or decrease by an amount and then compare the resulting efficiency to earlier traverses. The processor 102 will include estimates of the current mass of the vehicle in the estimations of best performance. The processor 102 may also include ambient conditions such as wind speed, air humidity and temperature, and precipitation in assessing those variables that affect the selection of speed or braking to continuously improve the performance over wider and wider ranges of ambient condition changes.

In another example, the system 100 is configured to provide a planned origin and destination of a trip to a driver. The processor 102 may be configured to search the records in the memory 108 or the remote database 122 to determine the trips that may utilize roadways previously traversed based on the most fuel-efficient speed established on the portions of the roadways, or time efficient speed with fuel optimization. The processor 102 also may also improve the effectiveness of the plan by using the data stored in the memory 108 and the database 122 by optimizing the energy consumption, and speed of driving on a selected road. Combining the driver preferences already experienced, and the data generated internally or external to the vehicle, the processor 102 may determine a plan of driving on a selected road to take the vehicle to the destination as efficiently and smoothly as possible in the time required by the driver or by the rules of the road. For example, some drivers or passengers are susceptible to car sickness induced on curvy roads. The processor 102 may be configured to cause the vehicle to deliberately enter each curve at a reduced speed, then accelerate through the curve to reduce the potential nausea, by slowing in the curve. The processor 102 may be configured to determine the plan of driving using the previous data stored in the database 122.

The driver may use the plan to commence the trip. In some examples, in the plan, the processor 102 may estimate that the vehicle has sufficient fuel to make the entire trip, and so does not schedule refueling or recharging stops, but does plan a rest break for the driver from time to time.

The driver may overrule some of the rest breaks planned or add new rest breaks in the plan by keeping driving.

If a weather front is expected to create rainy conditions for a portion of the trip based on the weather forecast or real time measurement, the processor 102 is configured to adjust the optimizing parameters, for example, when the rain sensors detect water on the road or the windshield.

In another example, the driver may use a wired or wireless interface such as a smart phone to input information about the vehicle and then engage the system 100, which may transmit the planned route or the plan to the communication device 110, such as a smart phone, before proceeding over a roadway. The processor 102 may use the positioning device 104 or other localizing interface in the communication device 110, such as a smart phone, to determine the position of the vehicle. As well, through the communication device 110, the system 100 may access data from other vehicles on the proposed section of road and plan the timing and amount of acceleration and deceleration, and speed profiles to provide the most fuel-efficient or other desired objective for the operation of the vehicle on the selected road. As with a cruise control, the driver immediately can suspend the control of the system by pressing the brake pedal of the vehicle and resume the use of the control of the system 100 with the buttons to control the cruise control, or with other buttons or voice command. As described above, other sensors and programs within the communication device 110 or smart phone, such as accelerometers and voice controls such as Siri™, can also assist in optimizing the operation of the vehicle to achieve the most fuel efficient- or other objective driving on a selected road. In some examples, Siri™ or Waze™ or other services, may be used to report the momentary conditions. The processor 102 is configured to set or modify operational parameters including the additional information received from Siri™ or Waze™.

The processor 102 may save, in the memory 108 the database 122 and/or in the communication device 110, the data from the traverse estimating the energy consumed by the acceleration profiles of the vehicle and known characteristics of that type of vehicle as input by the driver. The saved data can be later used in future traverses using the data saved by the processor 102.

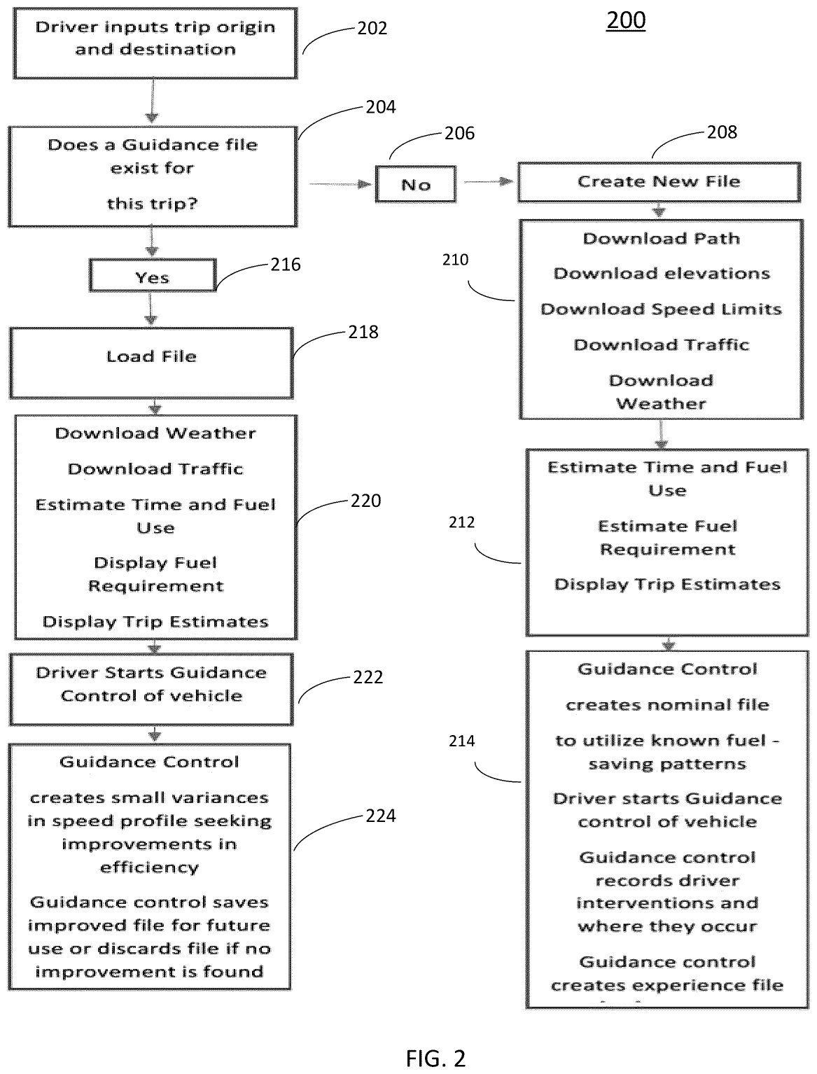

As described above, the processor 102 has operational information of vehicle, that may include speed, vehicle position, use of brakes, traffic, and vehicle fuel consumption, and thus can control vehicle speed and energy consumption based on this information. FIG. 2 is a flow chart illustrate a method 200 that may be implemented by the system 100 or processor 102, according to an embodiment of the present application.

In method 200, at step 202, a driver inputs trip origin and destination of a trip of the vehicle wherein the system 100 is mounted.

At step 204, the processor is configured to determine whether a guidance file exist for the trip. The guidance file is generated by the processor 102 and specifies energy consumption, speed, and operational parameters of the vehicle at specific locations along a road involved in the trip in view of the characteristics of the road.

At step 206, the processor 102 determines that no such guidance file exists for the trip.

At step 208, the processor 102 is configured to create a new file to set out specific energy consumption, speed, and operational parameters of the vehicles at specific locations of some or all the roads involved in the trip.

At step 210, the processor 102 is configured to download, for example from the memory 108 or the database 122, the path of the trip, download the elevations, speed limits, traffic, and the weather of the roads involved in the trip. An example of download may use any or all of: GPS data measuring vehicle position along the planned route, the weather data from forecasts along the planned route, topographic data such as available from Google Earth™ for the planned path, the current fuel levels in the vehicle, traffic and speed data from providers such as Waze™, and any centrally stored data for previous traverses over the planned route.

At step 212, the processor 102 is configured to estimate, for example from the previous trips on the relevant roads of the trip in the memory 108 or the database 122, time of the trip, energy consumption of the trip, and energy requirement for the trip. In some examples, the processor 102 may use estimated fuel consumption on the trip based on one or more of the following: the previous trips over the same roadway, other people's trips over the same roadway downloaded from a central database or local database, the characteristics of the vehicle being used for the trip such as drag coefficient, mass, tire type and condition, engine characteristics, expected temperatures and wind conditions, speed limits, and traffic expected. The result will be an estimate of expected duration of the trip, fuel consumption of the trip, use of forward-looking radar or lidar to control distance to cars ahead, and planned rest breaks at intervals chosen by either the program or the driver. In some examples, the processor 102 is configured to continuously monitor, update and/or forecast fuel use of the vehicle. Because the mass of the vehicle is one of the controlling parameters, carefully estimating fuel range can allow the vehicle to travel farther on lower fuel levels. In the example of electric vehicles and plug-in hybrids, the processor 102 is configured to continuously monitor, update battery use of the vehicle, and to optimize the time spent recharging.

The processor 102 may also be configured to display the estimates on a display of the communication device 110 or the vehicle. In some examples, the processor 102 may use a visual display to present relevant data to the driver, chosen from the estimated time and fuel needed, real time fuel consumption with comparison to the planned consumption, weather, traffic, alternate routes, and others. The display may be on a mobile phone screen, or other screen available in the vehicle.

Based on the downloaded information at step 208 and the estimates at step 212, at step 214 the processor 102 is configured to create a new guidance file to provide guidance control. The processor 102 is configured to use the new guidance file for applying known energy-saving patterns, for example, by controlling the energy consumption, speed, and operational parameters of the vehicle on the roads involved in the trip.

Using the new guidance file, or if a guidance file exists for the trip, at step 218, the processor 102 loads the guidance file to allow the processor 102 to control the vehicle in the trip. The processor 102 may control the vehicle.

At step 220, if a guidance file exists, same as step 210, the processor 102 is configured to download, for example from the memory 108 or the database 122, the traffic, and the weather of the roads involved in the trip, and to estimate, for example from the previous trips on the relevant roads of the trip in the memory 108 or the database 122, time of the trip, energy consumption of the trip, and energy requirement for the trip. The processor 102 may also be configured to display the estimates, such as fuel requirements and trip estimates, on a display of the communication device 110 or the vehicle.

At step 222, the processor 102 is configured to use the guidance file to control the energy consumption, speed, and operational parameters of the vehicle on the roads involved in the trip.

At steps 214 or 222, the processor 102 using the guidance file to control the vehicle includes some or all of the following: display of choices to allow the driver to choose minimum speed and maximum speed relative to posted speed limits, to prioritize speed or efficiency on a sliding scale, bypassing or accepting planned breaks, distance to follow leading vehicles, modification of deceleration and acceleration in curves to help mitigate car sickness, suspending or resuming Guidance, map guidance from traffic awareness providers such as Waze™, capacity and availability of charging stations, any other operational goals, and on completion of a trip, the option to save the Guidance file with a custom name.

At step 224, the processor 102 is configured to create variances from the speed profile specified in the guidance file to improve the efficiency in energy consumption. The processor 102 may record and save the variances in speed and actual energy consumption in a new file for future optimization or discard the new file if the variances do not lead to reduction of energy consumption.

During the trip, the driver may override the control of the processor 102 at any time. The processor 102 may record the driver's interventions and timing of the intervention during the trip, and the resulting improvements or detriments to the expected mileage or timing.

As well, after the trip is complete, the processor 102 may create a driving experience file involving information of the trip, including energy consumption, speed, and operational parameters of the vehicle, environmental information, and driver interventions. With the experience file, the processor 102 may be configured to identify the optimal energy consumption, speed, and operational parameters of the vehicle in the subsequent trips, for example, by comparing the experience files or portions of files to identify the experience file or portions of files with the most efficient energy consumption.

Certain adaptations and modifications of the described embodiments can be made. Therefore, the above discussed embodiments are considered to be illustrative and not restrictive.

What is claimed is:

1. A method for controlling energy consumption of a vehicle, comprising:
providing, by a processor, a guidance file for a trip of the vehicle; and
controlling, by the processor, based on the guidance file, one or more of energy consumption, and operational parameters of the vehicle in the trip.

2. The method of claim 1, further comprising controlling, by the processor, based on the guidance file, a speed of the vehicle in the trip.

3. The method of claim 1, further comprising:
creating, by the processor, variances from a speed profile specified in the guidance file to seek improvement in efficiency of the vehicle's energy consumption.

4. The method of claim 3, further comprising:
recording, by the processor, the variances in speed, position and actual energy consumption in a second file.

5. The method of claim 1, wherein providing the guidance file further comprises:
creating, at the processor, a second file for a trip of the vehicle;
retrieving, by the processor, road characteristics of the trip; and
creating the guidance file from the second file and the current road characteristics.

6. The method of claim 5, wherein providing the guidance file further comprises:
downloading, by the processor, weather data of roads involved in the trip; and
estimating, by the processor, time of the trip, energy consumption of the trip, and energy requirement for the trip.

7. The method of claim 1, further comprising:
creating, by the processor, a driving experience file comprising one or more of energy consumption, speed, operational parameters of the vehicle, environmental information, and driver interventions during the trip.

8. The method of claim 1, further comprising controlling, by the processor, the vehicle entering each curve at a reduced speed, and accelerating through the curve based on the guidance file.

9. The method of claim 1, further comprising scheduling, by the processor, refueling or recharging stops, or planning, by the processor, a rest break for the driver.

10. A method for controlling energy consumption of a vehicle, comprising:
providing, by a processor, a guidance file for a trip of the vehicle; and
controlling, by the processor, based on the guidance file, that includes position information of the vehicle, one or more parameters selected from energy consumption, speed, and operational parameters of the vehicle in the trip.

11. The method of claim 10, further comprising:
creating, by the processor, variances from a speed profile specified in the guidance file to seek improvement in efficiency of an energy consumption of the vehicle.

12. The method of claim 11, further comprising:
recording, by the processor, variances in speed, position and actual energy consumption in a second file.

13. The method of claim 10, wherein providing the guidance file further comprises:
creating, at the processor, a second file for a trip of the vehicle;
retrieving, by the processor, road characteristics of the trip; and
creating the guidance file from the second file and the current road characteristics.

14. The method of claim 12, wherein providing the guidance file further comprises:
downloading, by the processor, weather data of roads involved in the trip; and
estimating, by the processor, time of the trip, energy consumption of the trip, and energy requirement for the trip.

15. The method of claim 10, further comprising:
creating, by the processor, a driving experience file comprising one or more of energy consumption, speed, operational parameters of the vehicle,
environmental information, and driver interventions during the trip.

16. The method of claim 10, further comprising controlling, by the processor, the vehicle entering each curve at a reduced speed, and accelerating through the curve based on the guidance file.

17. The method of claim 10, further comprising scheduling, by the processor, refueling or recharging stops, or planning, by the processor, a rest break for the driver.

18. The method of claim 10, further comprising adjusting, by the processor, operating parameters of the vehicle based on environmental conditions.

19. The method of claim 10, wherein the processor is configured to control the vehicle using at least one of:
displaying of choices to allow the driver to choose minimum speed and maximum speed relative to posted speed limits;
prioritizing speed or efficiency on a sliding scale;
bypassing or accepting planned breaks;
determining a distance to follow leading vehicles;
modifying deceleration and acceleration in curves to help mitigate car sickness;
suspending or resuming the guidance file, considering map guidance from traffic awareness providers; and
saving the guidance file.

20. A system for controlling energy consumption of a vehicle, comprising:
a processor configured to:
provide, by the processor, a guidance file for a trip of the vehicle; and
control, by the processor, based on the guidance file, that includes position information of the vehicle, one or more parameters selected from energy consumption, speed, and operational parameters of the vehicle in the trip.
